(19) United States
(12) Patent Application Publication
(10) Pub. No.: US 2003/0150567 A1
(43) Pub. Date: Aug. 14, 2003

(54) Releasable cord apparatus and breakaway end portion for window treatments

(76) Inventors: James J. Hyman, Los Angeles, CA (US); Robert S. LeBlanc, Powder Springs, GA (US)

Correspondence Address: Oppenheimer Wolff & Donnelly LLP, Suite 3800, 2029 Century Park East, Los Angeles, CA, 90067, US

(21) Appl. No.: 10/074,693

(22) Filed: Feb. 12, 2002

(51) Int. Cl. E06B 9/324

(52) U.S. Cl. 160/178.2

(57) ABSTRACT

A window treatment includes a cord locking system, a breakaway end portion for a cord, and a releasable cord connection apparatus to prevent children or pets from becoming entangled in cords. A cord locking system includes a locking mechanism, a rotating portion and a spring portion. A breakaway end portion includes a housing, a stop portion, and at least one track. A releasable cord connector apparatus includes a receptive member and a connective member that inserts into the receptive member and releases when a force is applied.

### BACKGROUND OF THE INVENTION

1. Field of the Invention:

The present invention relates generally to indoor and outdoor window treatments, such as venetian blinds and roll up shades. Specifically, the present invention provides releasable safety devices used with cords on window treatments for preventing injury, including a releasable cord lock and a breakaway end portion for use with cords.

2. General Background and State of the Art

Window coverings, or blinds, typically have a horizontal or vertical covering to prevent sunlight from entering an area and to retain privacy. The covering, which is commonly in the form of slats or pleats, can hang vertically in the case of a vertical covering, or can extend horizontally from a headrail in the case of a horizontal covering. Many window coverings also include a bottom rail as well.

Window coverings often include a pull cord(s). Two or more cords are often provided to raise or lower the blind system evenly. The covering is raised or lowered by pulling or releasing the accessible portion of the cords. Because all cords must move in unison, they are typically joined together at an accessible place and then finished with tassels. Single cords and multiple cords that end up at the tassel without being separated present a danger to children and pets because they can become entangled in the cords and suffocate or accidentally hang themselves.

Window coverings may also include additional cords coupled to the covering portion. These may or may not pass through the slats that comprise the covering. In order to raise and lower the covering relative to the floor, a looped cord(s) extends from a point along the bottom of the covering into the headrail. When the pull cords are pulled by a user, the additional cords allow the covering to be raised or lowered. These additional cords can also present a danger to children or pets because they can also become entangled in the cords, which may result in injury or death.

All cords and tassels must now be separable from the window covering apparatus by recommendation of the Window Covering Safety Council. In accordance with this effort, there have been several attempts to minimize or eliminate the possibility of entanglement in the cords. In U.S. Pat. No. 5,577,543, a child safety device in a tassel is disclosed. The device includes a cutting means to cut cords, such as a blade, in case a person becomes entangled. However, the tassel may drop to the floor and become damaged, causing the blade to protrude from the tassel. Also, the detached tassel could be placed in a child's mouth, resulting in choking and possibly death.

In U.S. Pat. No. 6,044,523, a breakaway tassel is disclosed. In this device all the cords except one can break away from the tassel when a force is applied to the cords. However, it is still possible for the tassel to be inserted into the mouth. The non-breakaway cord can be used to pull the tassel from the mouth of an infant. However, the tassel still poses a threat if it is not removed in a timely manner. Furthermore, the process of removing the tassel may damage the throat and/or the sensitive lining in the mouth of an infant.

In U.S. Pat. No. 5,562,140 a releasable operating cord connector is disclosed. This connector is part of a tassel that detaches from the cords when a force is applied to the cords, thereby causing the tassel to drop to the floor. However, an infant can pick up the tassel and insert it into the mouth, thereby causing suffocation and possible death.

### INVENTION SUMMARY

The present invention provides a releasable locking system for cords in a window treatment. In one embodiment, the present invention includes a locking system having a locking mechanism and a rotating portion, a housing for holding the locking mechanism and the rotating portion, and a cord having a cord portion disposed within the housing between the locking mechanism and the rotating portion. The cord is releasable from the housing when a force is applied to the cord.

The present invention also provides a breakaway apparatus for a cord in a window treatment. A breakaway end portion disposed on an end of a cord portion includes a housing, at least one recessed track, and a stop portion movable along the recessed track within the housing. The recessed track of the breakaway end portion allows the cord to separate from the housing as the stop portion moves along the recessed track when a downward force is applied to the cord.

The present invention also provides a window treatment apparatus having a window covering portion, a headrail portion, a cord, and a cord locking system disposed inside the headrail portion. The window treatment apparatus also includes a first connective member having a first end releasably insertable into a first receptive member and a second end connected to a cord portion of the cord. The window treatment apparatus also includes a breakaway end portion disposed on an end of a cord portion. The cord locking system releasably locks a first cord portion of the cord inside the headrail portion. A force applied to the first cord portion causes the locking mechanism to release from a locked position and allow the first cord portion to pass between the locking mechanism and the rotating portion. The first connective member releases from the first receptive member when a force is applied to the second cord portion.

Accordingly, it is one object of the present invention to provide a cord locking system for cords in window treatments. It is another object of the present invention to provide a breakaway tassel or end portion for positioning on an end of a cord. It is yet another object of the present invention to provide a window treatment having a releasable cord locking system and breakaway end portion.

It is also an object of the invention to provide safety devices to prevent children and pets from becoming entangled in cords for a window treatment.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a front view of the releasable cord connection apparatus;

FIG. 2 is a top view of a headrail showing a releasable cord connection apparatus in accordance with another embodiment of the present invention;

FIG. 3 is a rear view of the releasable cord connection apparatus;

FIG. 4 is a perspective view of the receptive and connective components of the releasable cord connection apparatus;

FIG. 5 is a close-up view of a cord locking system in accordance with the present invention, with the cord locking system in a locked position;

FIG. 6 is a close-up view of a cord locking system in accordance with the present invention, with the cord locking system in a released position;

FIG. 7 is a close-up perspective view of a breakaway end portion of a cord in accordance with the present invention;

FIG. 8a is a close-up cross-sectional view of a breakaway end portion of a cord and having a cord loosely positioned therein in accordance with the present invention;

FIG. 8b is a close-up cross-sectional view of a breakaway end portion of a cord and having a cord tightly positioned therein in accordance with the present invention;

FIG. 9 is a front view of a window treatment in accordance with the present invention;

FIG. 10 is a top view of a headrail showing a releasable cord connection apparatus in accordance with another embodiment from that of FIG. 2;

FIG. 11 is a back view of a window treatment in accordance with the present invention;

FIG. 12a is a close-up view inside a headrail portion of a window treatment apparatus showing a pulley mechanism;

FIG. 12b is a close-up view inside a headrail portion of a window treatment apparatus showing a cord lock system;

FIG. 13 is a perspective view of a cord locking system having a connective member releasably inserted in a portion thereof in accordance with the present invention; and

FIG. 14 is a perspective view of a pulley mechanism having a connective member releasably inserted in a portion thereof in accordance with the present invention.

### DETAILED DESCRIPTION OF THE EMBODIMENTS

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

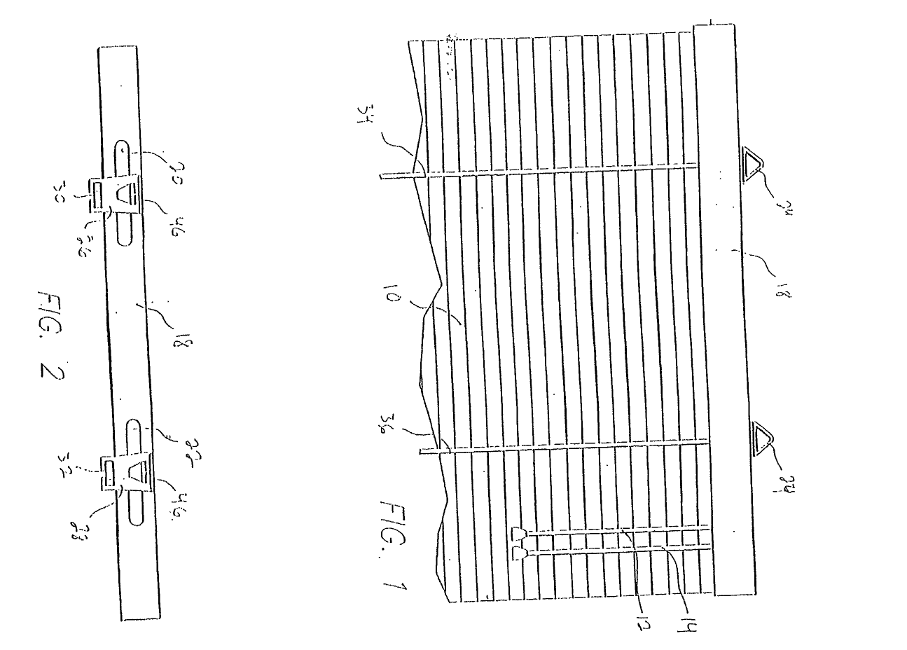

FIG. 1 is a front view of a releasable cord connection apparatus and window treatment. The releasable cord connection apparatus has a window covering 10 and a cord system having, in one embodiment, two looped cords and two pull cords. The looped cords include a first looped cord 34 and a second looped cord 36, and the pull cords include a first pull cord 12 and a second pull cord 14. When the window covering 10 is in a rolled up position, the cords 12, 14, 34 and 36 can easily be reached by children or pets. A first end of each pull cord 12 and 14 connects to a tassel. In one embodiment, multiple tassels can be used for multiple cords, and the multiple tassels can be tied together into a common tassel for uniform lift action. The window covering 10 may be a window blind with horizontal or vertical slats, or it may have a roll-up portion made of polyvinyl chloride, bamboo, or any other material commonly used to make roll-up window coverings.

Window treatments of the present invention include cords for allowing the window covering to roll up and down. Often, the cords including a plurality of cord portions which may take the form of a pull cord and an inner, looped cord. Window treatments may also have multiple pull cords and multiple inner, looped cords. They may also have different numbers of each of the pull and inner cords in various embodiments. It is to be understood that the various embodiments of the present invention may be applied to any cord used to maneuver a window treatment.

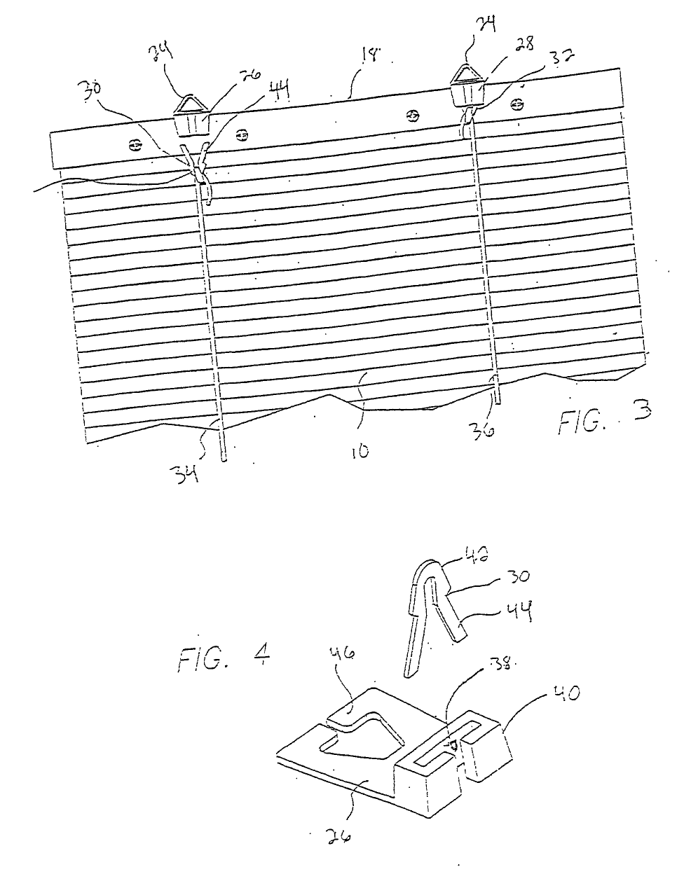

FIG. 2 is a top view of the headrail 18. The headrail 18 includes a first slot 20 and a second slot 22. Each slot holds a hanging mechanism 24 that slides in a linear manner in each slot. This allows a person to align each hanging mechanism for connection to a wall or window portion. FIG. 2 also shows a first receptive member 26 and a second receptive member 28. Each receptive member 26 and 28 has a first section that is configured to fit over the hanging mechanism 24 to removably couple to the headrail. In one embodiment, the first section is deformable so that it is able to stretch and fit over the hanging mechanism. In another embodiment, the first section includes a slot that is wide enough to fit over the hanging mechanism. FIG. 2 also shows a top of a first connective member 30 and a top of a second connective member 32, each of which is releasably inserted into a respective receptive member.

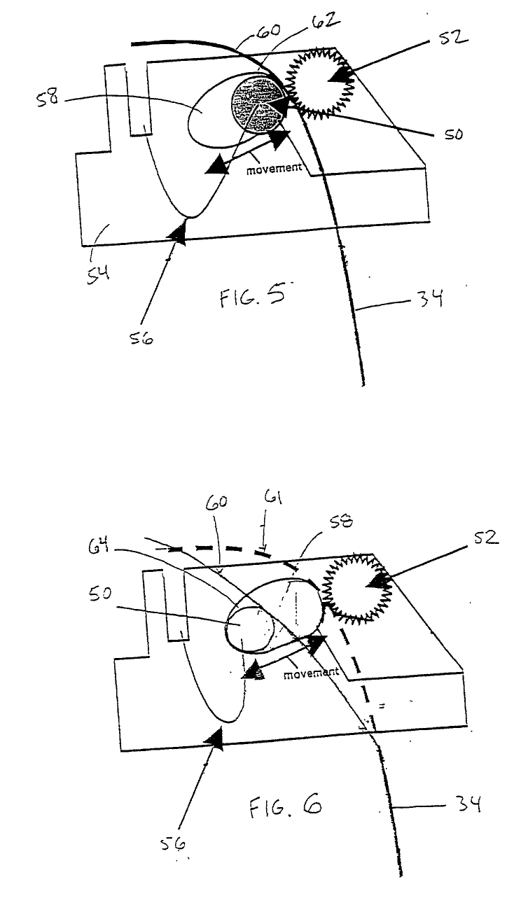

FIG. 3 is a rear view of the releasable cord connection apparatus. FIG. 3 shows the first receptive member 26 and the second receptive member 28 coupled to the headrail 18. In the embodiment shown in FIG. 3, the first receptive member 26 and the second receptive member 28 are coupled such that they are positioned on the top and down a back side of the headrail 18. Although FIG. 3 shows two receptive members, it is to be understood that the invention also contemplates that any number of receptive members could be coupled to the headrail 18. Further, the receptive members may be either fixedly coupled to the headrail, or they may be removably coupled. One example of the receptive members being removably coupled to the headrail 18 is shown in FIG. 2, where each receptive member has a first deformable end that fits over each hanging mechanism. In another embodiment in which the receptive members are fixedly coupled, the receptive members may be bolted or screwed to the headrail 18 such that they are permanently coupled to the headrail 18.

FIG. 3 also shows the first connective member 30 and the second connective member 32. Each connective member 30 and 32 is configured to be releasably insertable into a receptive member. Each connective member 30 and 32 is also coupled to a cord. FIG. 3 shows a first cord 34 coupled to the first connective member 30 and a second cord 36 coupled to the second connective member 32. The cords 34 and 36 may be releasably coupled to the connective members 30 and 32 by tying an end of each cord through a semi-arcuate end 42 of each connective member 30 and 32. Although FIG. 3 shows two connective members and two cords, it is to be understood that any number of connective members can be used to releasably insert into a corresponding number of receptive members, and also that a corresponding number of cords may also couple to the connective members.

The first connective member 30 is shown in FIG. 3 as being released from the first receptive member 26. In contrast, the second connective member 32 is shown releasably inserted into the second receptive member 28. Each receptive member 26 and 28 includes a recess 38 at a second end 40. Each connective member 30 and 32 also includes a semi-arcuate end 42 and two elongate pieces 44 extending out from the semi-arcuate end 42. In a released position, the two elongate pieces 42 are angled apart from each other, with the distance between the pieces increasing as they move farther away from the semi-arcuate end 40.

Each connective member 30 and 32 is sufficiently large so as not to be easily inserted into the mouth of a child after release from a receptive member. Furthermore, each connective member 30 and 32 has a smooth surface with no jagged, sharp or protruding edges that could injure a child if placed in the mouth.

The receptive members 26 and 28 and the connective members 30 and 32 may be made of any plastic material capable of withstanding prolonged exposure to heat so that the receptive members do not melt or become brittle. The plastic material used should also be able to slightly deform so that, for example, a receptive member would be able to receive a connective member and hold it in place. In one embodiment, the plastic material used to make the receptive and connective members is polypropylene. In this embodiment, the polypropylene material in the receptive members 26 and 28 provides sufficient elasticity to allow the receptive members 26 and 28 to expand and fit around each hanging mechanism 24 and then return to an original shape. Similarly, the polypropylene material allows the two elongate pieces 42 to bend inward and then expand to close to an original shape once inside the recess. Polypropylene therefore represents one example of a plastic material that can be used to make the receptive and connective members. In another embodiment, the receptive and connective members are made of acrylonitrile butadiene styrene, also known as ABS.

The receptive members and/or connective members may also be made of a metallic material. Metallic materials used should be capable of allowing a connective member to releasably insert into the receptive member, and should also have a sufficient degree of strength to provide a sturdy coupling that is not easily broken. The receptive and connective members do not have to be made of the same material. Therefore, in one embodiment, the receptive member is made of a metallic material, and the connective member is made of plastic material, with the plastic material being releasably insertable into the metallic material.

FIG. 4 is a perspective view of a receptive member and a connective member. The receptive member includes a deformable first end 46 and the second end 40 having the recess 38. The second end 40 having the recess 38 is positioned to be perpendicular to the deformable first end 46. This allows the receptive member to be positioned along the top and back side of a headrail 18 to provide an aesthetically pleasing appearance to the window covering having the releasable cord connection apparatus.

The connective member includes the semi-arcuate end 42 and the two elongate pieces 44 extending away from the semi-arcuate end 42. The two elongated pieces 44 are releasably insertable into the recess 38 of the receptive member by pinching the two elongate pieces 44 toward each other and inserting the two elongate pieces 44 into the recess 38. Once inside the recess 38, the two elongate pieces 44 move outward and hold the connective member inside the recess 38 by exerting force against the second end 40. When a force is applied to a cord coupled to the connective member, the two elongate pieces 44 are pinched inward by the walls of the second end 40 as a downward force is exerted on the connective member. As a result, the two elongate pieces 44 deform and release from the recess 38. After release, the connective member is easily re-insertable into the recess 38 by pinching the two elongate pieces 44 together and inserting into the recess 38.

The apparatus is designed such that the connective member releases from the receptive member when a force is applied to a cord. The apparatus is designed to protect small pets and infants weighing from about 10 pounds and large pets or children weighing under 100 pounds from becoming strangling in the cord or cords. At the same time, the apparatus is designed such that a relatively small force applied to the cords, such as for example when the cord is lightly pulled, does not cause the connective member to release from the receptive member. Similarly, the apparatus is also designed such that a rapid application of force to the cord, such as for example when a person rapidly pulls the cord to raise or lower the blinds, also does not cause the connective member to release from the receptive member. Therefore, the apparatus is designed such that any force sufficient to cause strangulation or other injury to pets or children will cause the connective member to release from the receptive member.

The releasable cord connection apparatus, the cord locking system, and the breakaway end portion are designed to break away under varying forces depending on the size of window treatments to which the apparatus is applied. Larger or wider window treatments require the application of a greater force to raise or lower the covering than small window coverings. As a result, for a larger window covering, the application of a light force that might cause the release of the connective member or cord in a smaller window covering would not cause the same break away response in the larger window covering. However, despite the differences in forces needed to raise and lower the window covering, the apparatus is nevertheless designed to cause the release of the connective member or cord when any force sufficient to cause strangulation or other injury to pets or children is applied.

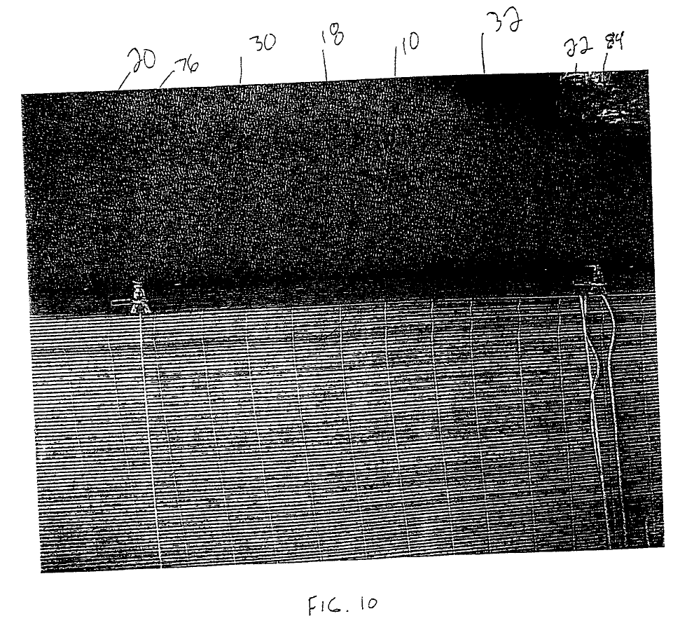

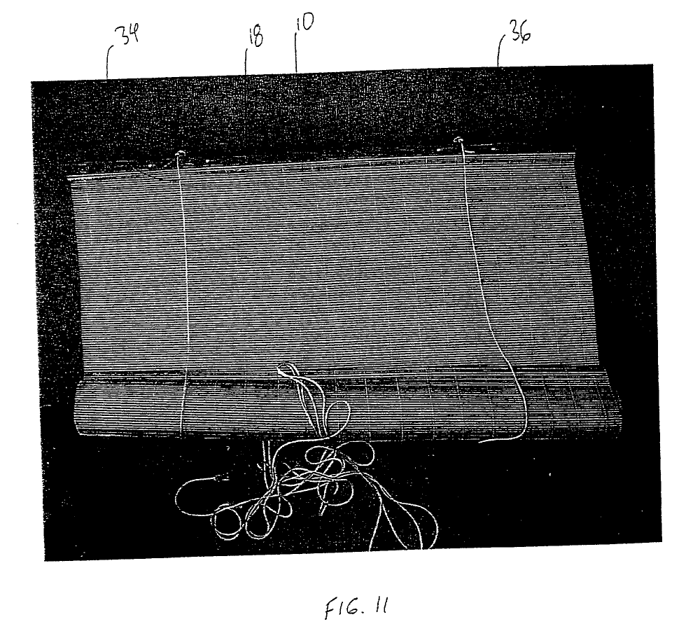

FIG. 5 is a close-up, cross-sectional view of a cord locking apparatus of the present invention. The cord locking apparatus includes a locking mechanism 50 and a rotating portion 52. The locking mechanism 50 and the rotating portion 52 may be disposed within a housing 54 and further disposed within the headrail portion 18 as shown in FIG. 8. The locking mechanism 50 may include a releasable bar 55 and may be coupled to a spring portion 56 and disposed within a recess 58 within the housing 54. An inner cord 34 or 36 of the cords of the present invention includes a first cord portion 60 that is disposed between the locking mechanism 50 and rotating portion 52. The locking mechanism and rotating portion secure the first cord portion 60 of the inner, looped cord inside the headrail portion 18 to allow a user to easily roll a window covering 10 up and down. FIG. 5 shows the locking mechanism in a locked, first position 62 such it causes pressure to be applied to the first cord portion of the inner, looped cord against the rotating portion. When usual force is applied to roll a window covering 10 up or down, the rotating portion rotates to allow the inner, looped cord to move between the locking mechanism and the rotating portion while still keeping pressure applied to the inner, looped cord.

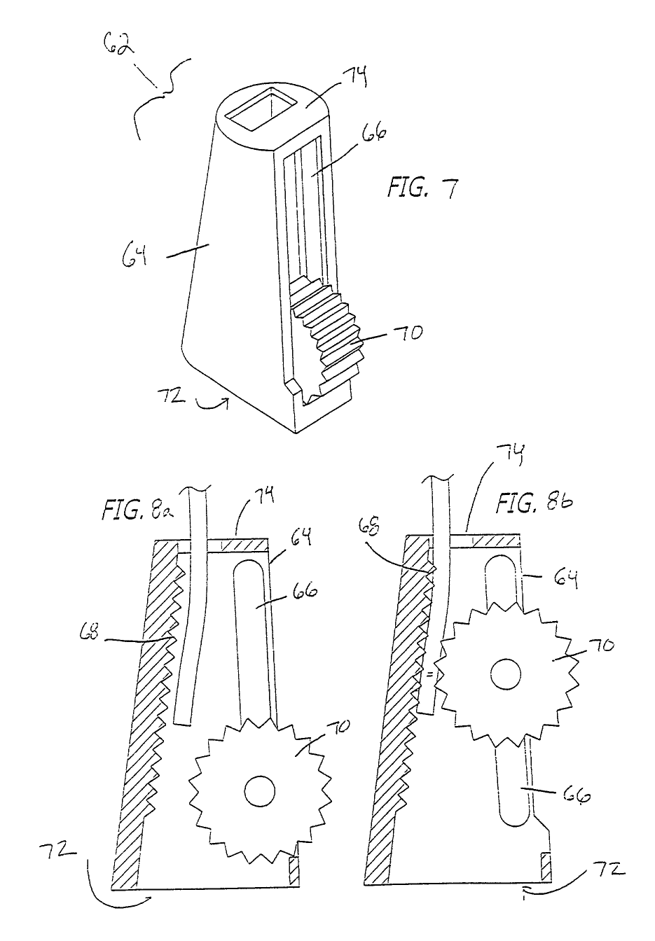

FIG. 6 is a close-up, cross-sectional view of a cord locking apparatus of the present invention. The locking mechanism 50 in FIG. 6 is in an unlocked, second position 64 such that pressure is relieved from the first end of the inner cord against the rotating portion. The configuration of FIG. 6 occurs when an excessive force is applied to the inner cord 34 or 36, such as for example when a child or pet becomes entangled in the cord. The excessive applied to the inner, looped cord forces the spring portion 56 to give way and allow the locking mechanism 50 to move within the recess 58. The locking mechanism 50 therefore moves away from the rotating portion 52, allowing the first cord portion 60 of the inner cord 34 or 36 to pass between the rotating portion 52 and locking mechanism 50 and fall to the ground, thereby preventing injury to children or pets tangled in the cord.

FIG. 6 also shows the positioning of the first end in both before a force is applied and after. Numeral 61 shows the positioning of the first cord portion, in outline form, prior to a force being applied. This positioning is the same as that of FIG. 5. Numeral 60 shows the positioning of the first cord portion of the cord after a force is applied. As discussed above, the force causes the releasable bar to move within the recess and permit the first cord portion 60 to pass between the releasable bar and the rotating portion.

Cords used in the present invention are also reattachable to the window treatment. After separating from the cord locking system, the first cord portion of a cord can be reattached by re-threading the first cord portion between the locking mechanism and the rotating portion. Therefore, users of a window treatment having the cord locking system safety feature can re-attach a fallen cord without having to purchase a new window treatment.

The cord locking system may be made generally of various materials for the different components. The releasable bar of the locking mechanism may be made of brass, or any other material suitable for applying pressure to a cord within a headrail. The spring portion may be made of galvanized steel. The rotating portion and housing may be made of ABS.

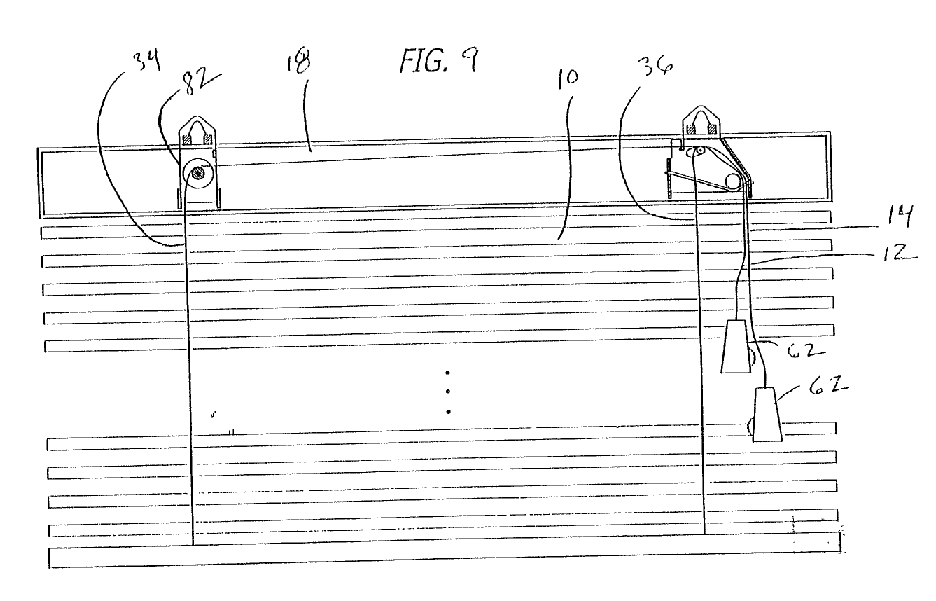

FIG. 7 is a close-up perspective view of a breakaway end portion 62. The breakaway end portion 62 includes a housing 64, a plurality of recess tracks 66, a grooved track 68, and a stop portion 70 that is grooved to move relative to the grooved track 68. The stop portion 70 includes elongated extension members extending out from either face of the stop portion that are disposed with the recessed tracks 66 to facilitate movement of the stop portion 70 along the recessed track 66. The housing 64 is configured at an angle, such that when the stop portion is near or at the bottom 72 of the housing, it fits tightly with the grooved track, and when the stop portion is near or at the top 74 of the housing, there is a space between the stop portion and the grooved track. When a force is applied to the cord, the end of the cord pulls the stop portion along the recessed tracks and grooved tracks towards the top of the housing. As the stop portion moves toward the top of the housing, the space between the stop portion and the grooved track grows larger, allowing the first end of the cord to move between the stop portion and the housing. Therefore, a sufficient force may cause the space between the stop portion and the grooved track to widen enough to allow the first end of the cord to pass between the stop portion and the grooved track and separate from the housing through a hole at the top of the housing.

FIG. 8a is a close-up cross-sectional view of a breakaway end portion 62 disposed on an end of a cord. The stop portion is positioned at the bottom 72 of the housing 64. In this position, the end of the cord is loosely positioned. FIG. 8b is an additional close-up perspective view of a breakaway end portion 62 disposed on an end of a cord. The end of the cord is disposed between the stop portion 70 and the grooved track 68. In this position, the end of the cord is secured in the housing 64 in a tight position such that it stays inside the housing with normal use.

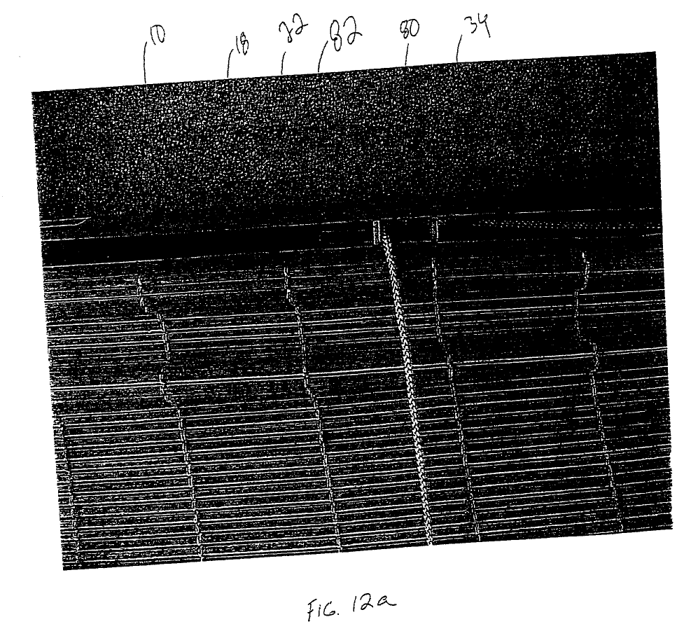

FIG. 9 is a front view of a window treatment in accordance with one embodiment of the present invention, showing a cross-sectional view of the headrail portion. The window treatment has a window covering 10 and a cord system having two looped cords and two pull cords. The looped cords include a first looped cord 34 and a second looped cord 36, and the pull cords include a first pull cord 12 and a second pull cord 14. The window covering 10 may be a window blind with horizontal or vertical slats, or it may have a roll-up portion made of polyvinyl chloride, bamboo, or any other material commonly used to make roll-up window coverings. The window covering in FIG. 9 is shown in a partially rolled-up position. The headrail portion 18 includes, on the inside, a cord lock system and a pulley mechanism. The top of the headrail 18 includes a releasable cord connection apparatus as described and shown in FIG. 10. The headrail portion includes, on the inside, a pulley mechanism 82 and the cord locking system having a locking mechanism 50 and a rotating portion 52.

FIG. 10 is a top view of the headrail portion 18 of a window treatment. The headrail portion 18 includes a first slot 20 and a second slot 22. One slot allows a top portion 76 of a housing 78 of a pulley mechanism 82 and to extend out from the inside of the headrail portion 18. The other slot allows a top portion 84 of the housing 54 of the cord lock system to extend out from the inside of the headrail portion 18. The top portions 76 and 84 slide in a linear manner in each slot. FIG. 10 also shows that the top portions 76 and 84 of the pulley mechanism and cord locking system serve as a first receptive member 26 and a second receptive member 28, respectively. Each receptive member 26 and 28 has a groove that is configured to allow the window treatment to be removably mounted on a wall or over a window.

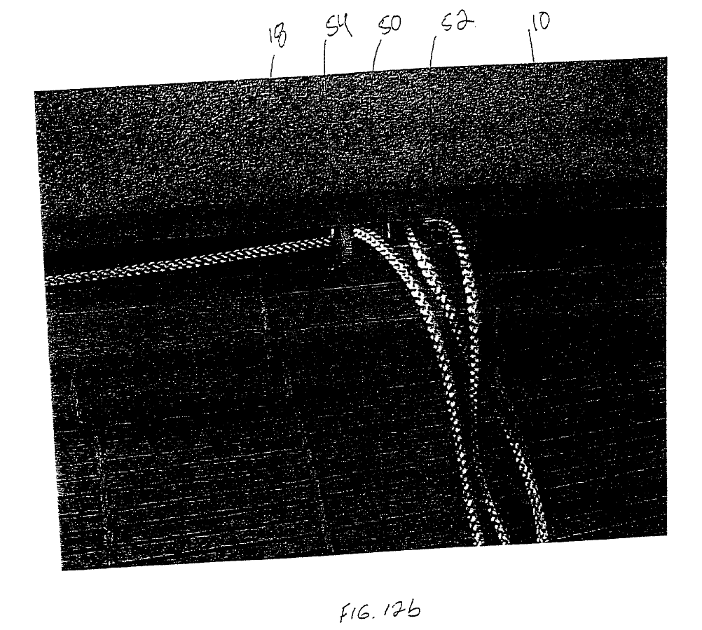

FIG. 11 is a rear view of the window treatment showing the releasable cord connection apparatus coupled to the headrail portion 18. FIG. 3 shows the first receptive member 26 and the second receptive member 28 coupled to the top portions 76 and 84 extending out from the headrail portion 18. FIG. 11 also shows the first connective member 30 and the second connective member 32. Each connective member 30 and 32 is configured to be releasably insertable into a receptive member. Each connective member 30 and 32 is also coupled to a cord. FIG. 11 shows a first cord 34 coupled to the first connective member 30 and a second cord 36 coupled to the second connective member 32. The cords 34 and 36 may be releasably coupled to the connective members 30 and 32 by tying an end of each cord through a semi-arcuate end 42 of each connective member 30 and 32. Although FIG. 11 shows two connective members and two cords, it is to be understood that any number of connective members can be used to releasably insert into a corresponding number of receptive members, and also that a corresponding number of cords may also couple to the connective members.

Each connective member 30 and 32 also includes two elongate pieces 44 extending out from the semi-arcuate end 42. In a released position, the two elongate pieces 42 are angled apart from each other, with the distance between the pieces increasing as they move farther away from the semi-arcuate end 40.

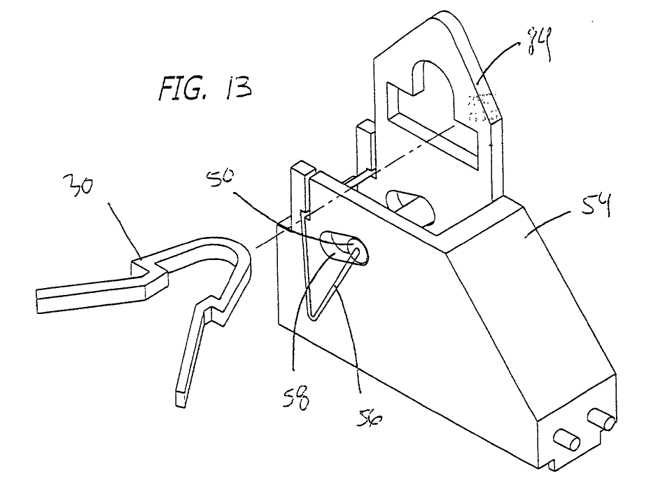

FIG. 12a is a close-up, perspective view of a headrail portion 18 of a window treatment, showing a pulley mechanism 82 from a bottom angle. FIG. 12b is a close-up, perspective view of a headrail portion 18 of a window treatment, showing a cord locking system from a bottom angle. FIG. 12a and FIG. 12b show inner, looped cords 34 and 36 coupled to a window treatment, and a window covering 10. FIG. 12b also show a cord locking system disposed inside the headrail portion and having a locking mechanism 50, a rotating portion 52, a releasable bar 55, a spring portion 56, a housing 54, and a recess 58. The housing 54, the locking mechanism 50 and the rotating portion 52 are disposed within the headrail portion 18. FIG. 12a also shows a pulley mechanism 82 disposed within the headrail portion 18 and including a housing 78 and a rotating member 80. The pulley mechanism 82 is disposed within the headrail portion 18 of the window treatment to allow a portion of the cord to move within the headrail as the covering 10 is rolled up and down.

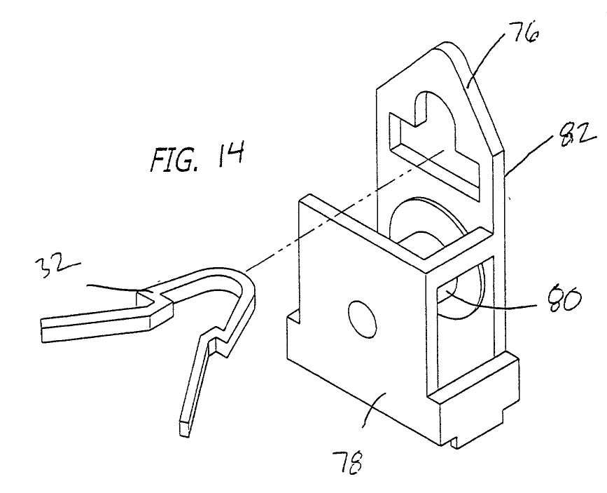

FIG. 13 is close-up perspective view of a cord locking system having a connective member 30 releasably inserted into a recess in the top portion 84 of the housing 54 of the cord locking system. The top portion 84 is the receptive member 26 that accepts the connective member 30, which is coupled to another portion of the cord. The housing 54 of the cord locking system may therefore serve as part of the releasable cord connection apparatus described in detail in FIG. 1. The top portion 84 may extend through a slot 20 in the headrail portion 18. The housing 54 of the cord locking system, including the top portion 84, may be made of a material such as PVC.

The cord locking system includes the locking mechanism 50 and the rotating portion 52 which may be disposed within a housing 54 and further disposed within the headrail portion 18 as shown in FIG. 12. The locking mechanism 50 may include a releasable bar 55 and may be coupled to a spring portion 56 and disposed within a recess 58 within the housing 54. An inner cord 34 or 36 of the set of cords of the present invention includes a first end 60 that may disposed between the locking mechanism 50 and rotating portion 52, as shown in FIG. 12 and in FIG. 5 and FIG. 6. The locking mechanism and rotating portion secure the first end 60 of the inner, looped cord inside the headrail portion 18 to allow a user to easily roll a window covering 10 up and down.

FIG. 14 is a close-up perspective view of the pulley mechanism 82 with a connective member 32 releasably inserted into a recess in the top portion 76. The top portion 76 is the receptive member 28 that accepts the connective member 32 coupled to another portion of the cord. The housing 78 of the pulley mechanism 82 may therefore serve as part of the releasable cord connection apparatus described in detail in FIG. 1. The top portion 76 may extend through a slot 22 in the headrail portion 18. The housing 78 of the pulley mechanism 82, including the top portion 76, may be made of a material such as PVC. The rotating member 80 may be made of a material such as galvanized steel. The pulley mechanism 82 includes a housing 78 and a rotating member 80 disposed in and coupled to the housing 78. The pulley mechanism 82 is disposed within the headrail portion 18 of the window treatment to allow a portion of the cord to move within the headrail as the covering 10 is rolled up and down. The housing 78 of the pulley mechanism 82 may include a top portion 76 that extends from the top of the headrail portion 18 as shown in FIG. 1.

It is to be understood that, since multiple cords can be used with a window treatment, that multiple cord locking systems and breakaway end portions may also be used with a window treatment. The locking mechanism and releasable bar of the present invention may take any shape, form or size suitable to facilitate the locking and releasing of a cord in a window treatment. Also, the rotating portion may take any shape, form or size suitable to allow a cord to move relative to the cord locking system.

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. For example, either the pull cords or the inner, looped cords may be used with the cord locking system of the present invention. Also, either of the pull cords or the inner, looped cords may be used with the releasable cord connection apparatus of the present invention. It is intended that all safety features described herein may be used in the same window treatment for any cord. It is therefore intended that the scope of the invention not be limited by this detailed description.

We claim:

1. A cord apparatus comprising:
a cord locking system including a locking mechanism and a rotating portion;
a housing for holding the locking mechanism and the rotating portion; and
a cord having a first end disposed within the housing between the locking mechanism and the rotating portion, wherein the cord is releasable from the housing when a force is applied to the cord, the force causing the locking mechanism to release from a first position and allow the cord to pass between the rotating portion and the locking mechanism.

2. The cord apparatus of claim 1, wherein the locking mechanism includes a spring portion and a releasable bar disposed in a recess in the housing.

3. The cord apparatus of claim 2, wherein the releasable bar moves from the first position in the recess of the housing to a second position in the recess of the housing when the force is applied to the cord.

4. A breakaway apparatus for a cord in a window treatment, comprising:
a breakaway end portion having a housing, at least one recessed track, and a stop portion movable along the at least one recessed track within the housing; and
a cord having a first end, the breakaway end portion disposed on the first end of the cord, wherein the at least one recessed track of the breakaway end portion allows the cord to separate from the housing as the stop portion moves along the at least one recessed track when a downward force is applied to the cord.

5. The apparatus of claim 4, further comprising a grooved track.

6. The apparatus of claim 5, wherein the stop portion is grooved to move along the grooved track within the housing.

7. The apparatus of claim 4, further comprising a plurality of recessed tracks, the stop portion having a plurality of elongated extension members disposed within the plurality of recessed tracks for moving the stop portion along the plurality of recessed tracks.

8. The apparatus of claim 4, wherein the first end of the cord is held within the housing by stop portion.

9. The apparatus of claim 6, wherein the stop portion fits tightly with the grooved track near a first portion of the housing, and wherein the stop portion fits loosely with the grooved track when the stop portion is near a second portion of the housing.

10. The apparatus of claim 9, wherein when a force is applied to the cord, the cord pulls the stop portion along the plurality of recessed tracks and the grooved track towards the second portion of the housing.

11. A method of providing a breakaway apparatus for a cord in a window treatment, comprising:
providing a cord having a first end and a breakaway end portion having at least one recessed track, a stop portion, and a housing, the breakaway end portion disposed on the first end of the cord, wherein the first end is held within the housing by the stop portion; and
allowing the breakaway end portion to separate from the first end of the cord when a downward force is applied to the cord.

12. The method of claim 11, further comprising providing a grooved track within the housing.

13. The method of claim 12, wherein the stop portion is grooved to move along the grooved track within the housing.

14. The method of claim 11, further comprising providing a plurality of recessed tracks within the housing.

15. The method of claim 14, further comprising providing a plurality of elongated extension members on the stop portion and disposed within the plurality of recessed tracks for moving the stop portion along the plurality of recessed tracks.

16. A method of providing a cord apparatus comprising:
providing a cord, a locking mechanism, a rotating portion, and a housing for holding the locking mechanism and the rotating portion; and
allowing the cord to be releasable from the housing when force is applied to the cord, the force causing the locking mechanism to release from a locked position and allow the cord to pass between the rotating portion and the locking mechanism.

17. The method of claim 16, wherein the locking mechanism moves to an unlocked position when a force is applied to the cord.

18. The method of claim 17, wherein the housing includes a recess, the locking mechanism being positioned within the recess and moving from the locked position to the unlocked position within the recess.

19. A window treatment apparatus comprising:
a window covering portion;
a headrail portion;
a cord;
a cord locking system disposed inside the headrail portion and including a locking mechanism, a rotating portion, and housing having a top portion extending out of the headrail portion and forming a first receptive member, the cord locking system releasably locking a first cord portion of the cord inside the headrail portion, wherein a force applied to the first cord portion causes the locking mechanism to release from a locked position and allow the first cord portion to pass between the locking mechanism and the rotating portion; and
a first connective member having a first end releasably insertable into the first receptive member and a second end connected to a second cord portion of the cord, the first connective member releasing from the first receptive member when a force is applied to the cord portion.

20. The apparatus of claim 19, further comprising a pulley mechanism disposed within the headrail portion.

21. The apparatus of claim 20, wherein the pulley mechanism includes a rotating member and housing forming a second receptive member.

22. The apparatus of claim 21, further comprising providing a second connective member having a first end releasably insertable into the second receptive member and a second end connected to a third cord portion of the cord, the second connective member releasing from the second receptive member when a force is applied to the third cord portion.

23. The apparatus of claim 19, further comprising a breakaway end portion disposed on a fourth cord portion of the cord.

24. The apparatus of claim 23, wherein the breakaway end portion includes a housing, at least one recessed track, and a stop portion movable along the at least one recessed track within the housing.

25. The apparatus of claim 22, wherein the first receptive member includes a recess disposed within the first receptive member, and wherein the first connective member is releasably insertable into the recess.

26. The apparatus of claim 25, wherein the second receptive member includes a recess disposed within the second receptive member, and wherein the second connective member is releasably insertable into the recess.

27. The apparatus of claim 26, wherein the first and second connective members are deformable.

28. The apparatus of claim 27, wherein the first and second connective members each include a semi-arcuate section and a linear section having two elongate pieces, the two elongate pieces releasably inserting into the recess of one of the first and second receptive members.

29. The apparatus of claim 19, wherein the locking mechanism includes a spring portion and a releasable bar disposed in a recess in the housing.

30. The apparatus of claim 29, wherein the releasable bar moves from the first position in the recess of the housing to a second position in the recess of the housing when the force is applied to the cord.

31. A method of providing a cord safety apparatus for a window treatment, comprising:
providing a window treatment having a covering, a headrail portion, and a cord having a plurality of cord portions;
providing a releasable cord connection system including at least one receptive member and at least one a connective member releasably insertable into the at least one receptive member, the at least one connective member being coupled to a first cord portion of the cord and being releasable from the at least one receptive member when a force is applied to the first cord portion;
providing a locking mechanism and a rotating portion disposed inside the headrail portion, and a second cord portion of the cord disposed inside the headrail portion between the locking mechanism and the rotating portion;
releasing the locking mechanism from a first position to a second position when a force is applied to the second cord portion; and
providing a breakaway end portion disposed on a third cord portion of the cord and releasable from the third cord portion when the force is applied to the third cord portion.

32. The method of claim 31, wherein the at least one receptive member is formed in a housing holding the locking mechanism and rotating portion inside the headrail portion, the at least one receptive member extending out of the headrail portion through a slot in the headrail portion.

33. The method of claim 32, further comprising providing a pulley mechanism disposed inside the headrail.

34. The method of claim 33, further comprising providing an additional receptive member and an additional connective member releasably insertable into the additional receptive member, the additional connective member being coupled to a fourth cord portion of the cord and being releasable from the additional receptive member when a force is applied to the fourth cord portion of the cord.

35. The method of claim 34, wherein the additional receptive member is formed in the housing holding the pulley mechanism inside the headrail, the additional receptive member extending out from the headrail portion through a slot in the headrail portion.

36. The method of claim 31, wherein the breakaway end portion includes a housing, at least one recessed track, and a stop portion movable along the at least one recessed track within the housing.

37. The method of claim 31, wherein the locking mechanism moves between the first position and the second position within a recess inside the housing.

38. The method of claim 35, wherein the at least one receptive member includes a recess disposed within the at least one receptive member, and wherein the at least one connective member is releasably insertable into the recess.

39. The method of claim 38, wherein the additional receptive member includes a recess disposed within the additional receptive member, and wherein the additional connective member includes a first end releasably insertable into the recess of the additional receptive member.

40. The apparatus of claim 39, wherein the at least one connective member and the additional connective member are deformable.

41. The apparatus of claim 40, wherein the at least one connective member and the additional connective member each include a semi-arcuate section and a linear section having two elongate pieces, the two elongate pieces releasably inserting into the recess of the at least one receptive member and the additional receptive member.

42. The cord apparatus of claim 31, wherein the locking mechanism includes a spring portion and a releasable bar disposed in a recess in the housing.

43. The cord apparatus of claim 32, wherein the releasable bar moves from the first position in the recess of the housing to a second position in the recess of the housing when the force is applied to the cord.

44. A window treatment apparatus comprising:
a window covering portion;
a headrail portion;
a cord;
a plurality of cord safety devices, including
a cord locking system disposed within the headrail portion and including a locking mechanism, a rotating portion, and a housing having a top portion, the cord locking system releasably locking a first cord portion of the cord inside the headrail portion, wherein a force applied to the first cord portion causes the locking mechanism to release from a locked position and allow the first cord portion to pass between the locking mechanism and the rotating portion;
a pulley mechanism disposed within the headrail portion and having a rotating member and a housing including a top portion;
a releasable cord connection system including a plurality of connective members, each connective member having a first end, wherein the first end of one connective member is releasably insertable into the top portion of the housing of the cord locking system, and wherein the first end of another connective member is releasably insertable into the top portion of the housing -of the pulley mechanism, each connective member also including a second end coupled to a second cord portion and third cord portion, respectively, the connective members being releasable from the top portions when a force is applied to the second and third cord portions; and
a breakaway end portion releasably disposed on a fourth cord portion, wherein the breakaway end portion includes a stop portion and a grooved track, the fourth cord portion being releasably disposed between the stop portion and the grooved track.
